(19) United States
(12) Patent Application Publication
(10) Pub. No.: US 2007/0194217 A1
(43) Pub. Date: Aug. 23, 2007

(54) Semiconductor photosensor

(75) Inventors: Yukiko Takiba, Kawasaki-shi (JP); Hiroshi Suzunaga, Kawasaki-shi (JP); Hideyuki Mori, Yokohama-shi (JP); Nozomu Takahashi, Ayase-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Minato-ku (JP)

(21) Appl. No.: 11/472,366

(22) Filed: Jun. 22, 2006

(30) Foreign Application Priority Data
Feb. 22, 2006 (JP) 2006-045639

(51) Int. Cl. G01J 3/50

(52) U.S. Cl. 250/226

(57) ABSTRACT

According to the present invention, there is provided a semiconductor photosensor having:
a first photo detector and a second photo detector formed in a surface portion of a semiconductor substrate;
a first resin layer formed on a light-receiving region of the first photo detector, and including a first spectral sensitivity characteristic;
a second resin layer formed on a light-receiving region of the second photo detector, and including a second spectral sensitivity characteristic; and
an operation circuit which performs a predetermined operation between a first output from the first photo detector and a second output from the second photo detector, and outputs a result of the operation,
wherein the first spectral sensitivity characteristic is a characteristic which removes a wavelength component in a short-wavelength region, and the second spectral sensitivity characteristic is a characteristic which removes a wavelength component in an infrared region.

### CROSS REFERENCE TO RELATED APPLICATION

This application is based upon and claims benefit of priority under 35 USC §119 from the Japanese Patent Application No. 2006-45639, filed on Feb. 22, 2006, the entire contents of which are incorporated herein by reference.

### BACKGROUND OF THE INVENTION

A semiconductor photosensor which outputs a linear signal in accordance with the ambient illuminance is widely used. Especially in a cellphone, the semiconductor photosensor is used to control ON/OFF of the backlight of a liquid crystal display or LEDs in a keypad in accordance with the ambient illuminance.

For example, the semiconductor photosensor is used as an illuminance sensor for turning off the backlight or the LEDs in the keypad when the environment is bright, and turning on the backlight or LEDs or performing brightness adjustment or the like when the environment is dark, thereby suppressing unnecessary power consumption.

To meet these demands, the semiconductor photosensor as an illuminance sensor is required to have a spectral sensitivity characteristic substantially equal to the spectral sensitivity of a human eye.

An illuminance sensor described in patent reference 1 (to be described later) is the conventional technique of obtaining the spectral sensitivity characteristic close to the visual sensitivity. This illuminance sensor includes a photodiode having an infrared transmitting filter and a photodiode having no infrared transmitting filter, and performs an operation between photocurrents generated from these photodiodes, thereby excluding infrared light from a detection wavelength band. In this manner, the sensitivity to infrared light can be excluded from the spectral sensitivity characteristic of the illuminance sensor.

The spectral sensitivity characteristic is conventionally improved at long wavelengths as described above, but it is not improved at short wavelengths. This produces a difference from the visual sensitivity at short wavelengths.

The reference disclosing the conventional semiconductor photosensor using an infrared transmitting filter is as follows.

Japanese Patent Laid-Open No. 2004-214341

### SUMMARY OF THE INVENTION

According to one aspect of the present invention, there is provided a semiconductor photosensor having: a first photo detector and a second photo detector formed in a surface portion of a semiconductor substrate; a first resin layer formed on a light-receiving region of the first photo detector, and including a first spectral sensitivity characteristic; a second resin layer formed on a light-receiving region of the second photo detector, and including a second spectral sensitivity characteristic; and an operation circuit which performs a predetermined operation between a first output from the first photo detector and a second output from the second photo detector, and outputs a result of the operation, wherein the first spectral sensitivity characteristic is a characteristic which removes a wavelength component in a short-wavelength region, and the second spectral sensitivity characteristic is a characteristic which removes a wavelength component in an infrared region.

According to one aspect of the present invention, there is provided a semiconductor photosensor having: a first photo detector and a second photo detector formed in a surface portion of a semiconductor substrate; a first resin layer formed on a light-receiving region of the first photo detector, and including a first spectral sensitivity characteristic; a second resin layer formed on a light-receiving region of the second photo detector, and including the first spectral sensitivity characteristic; a third resin layer formed on the light-receiving region of the second photo detector such that the second resin layer and the third resin layer are stacked, and including a second spectral sensitivity characteristic; and an operation circuit which performs a predetermined operation between a first output from the first photo detector and a second output from the second photo detector, and outputs a result of the operation, wherein the first spectral sensitivity characteristic is a characteristic which removes a wavelength component in a short-wavelength region, and the second spectral sensitivity characteristic is a characteristic which removes a wavelength component in an infrared region.

### BRIEF DESCRIPTION OF THE DRAWINGS

FIG. 1 is a circuit diagram showing the arrangement of a semiconductor photosensor according to the first embodiment of the present invention;

FIG. 2A is a sectional view showing the longitudinal sectional structure of photodiode portions in the semiconductor photosensor according to the first embodiment; FIG. 2B is a sectional view showing a modification of FIG. 2A;

FIG. 3A is a graph showing an example of the transmittance characteristic of a short-wavelength cut filter in the semiconductor photosensor according to the first embodiment; FIG. 3B is a graph showing an example of the transmittance characteristic of an infrared transmitting filter in the semiconductor photosensor according to the first embodiment; FIG. 3C is a graph showing an example of the characteristic of a photodiode usable in the semiconductor photosensor according to the first embodiment when no filter is used; FIG. 3D is a graph showing an example of the characteristic obtained in a photodiode portion 1 using only a short-wavelength cut filter in the semiconductor photosensor according to the first embodiment; FIG. 3E is a graph showing an example of the characteristic obtained in a photodiode portion 2 using a short-wavelength cut filter and an infrared transmitting filter 11 in the semiconductor photosensor according to the first embodiment; FIG. 3F is a graph showing an example of the characteristic finally obtained by using the photodiode portions 1 and 2 in the semiconductor photosensor according to the first embodiment;

FIG. 4A is a plan view showing an example of a chip layout pattern in the semiconductor photosensor according to the first embodiment; FIG. 4B is a plan view showing another example of the chip layout pattern in the semiconductor photosensor according to the first embodiment;

FIG. 5 is a circuit diagram showing the arrangement of a semiconductor photosensor according to a reference example;

FIG. 6 is a graph showing an example of the spectral sensitivity characteristic of the semiconductor photosensor according to the reference example;

FIG. 7 is a graph showing the light emission spectra of various light sources;

FIG. 8 is a circuit diagram showing the arrangement of a semiconductor photosensor according to the second embodiment of the present invention;

FIG. 9 is a circuit diagram showing the arrangement of a semiconductor photosensor according to the third embodiment of the present invention;

FIG. 10A is a sectional view showing the longitudinal sectional structure of photodiode portions in a semiconductor photosensor according to the fourth embodiment of the present invention; FIG. 10B is a sectional view showing a modification of FIG. 10A; and

FIG. 11 is a sectional view showing the longitudinal sectional structure of photodiode portions in a semiconductor photosensor according to the fifth embodiment of the present invention.

### DETAILED DESCRIPTION OF THE INVENTION

Embodiments of the present invention will be described below with reference to the accompanying drawings.

### (1) First Embodiment

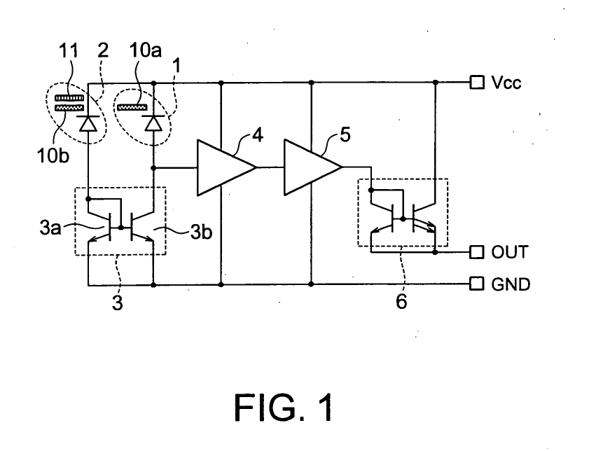

FIG. 1 shows the circuit-configuration of a semiconductor photosensor according to the first embodiment of the present invention. This semiconductor photosensor has photodiode portions 1 and 2, amplifiers 3, 4, and 5, and an output circuit 6.

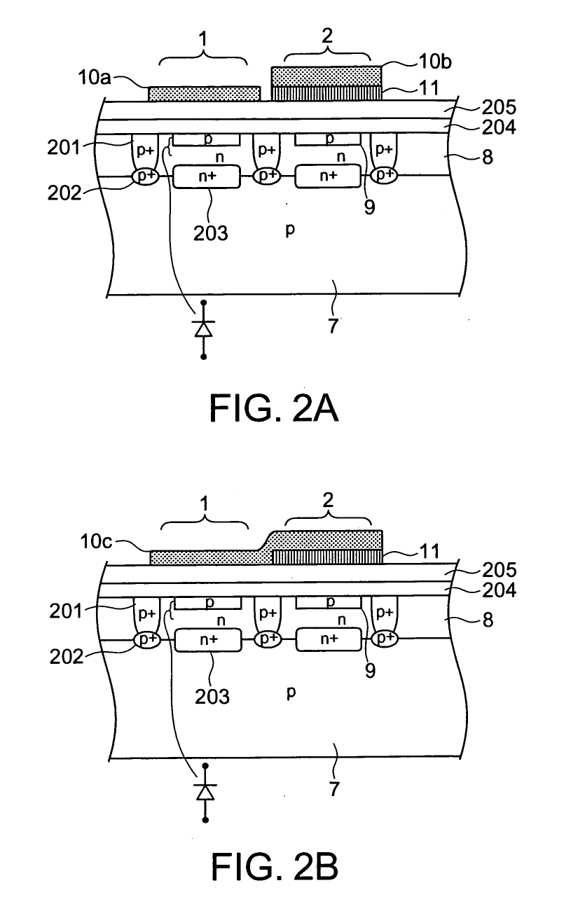

FIG. 2A shows the longitudinal sectional structure of the photodiode portions 1 and 2.

The photodiode portion 1 is formed by an n-type epitaxial layer 8 formed on a p-type semiconductor substrate 7, and a p-type diffusion layer 9 formed on the surface of the n-type epitaxial layer 8. A short-wavelength cut filter 10a which removes light in a short-wavelength region is formed on top of the resultant structure via insulating films 204 and 205.

The photodiode portion 2 has the same photodiode structure as the photodiode portion 1. In addition, an infrared transmitting filter 11 and short-wavelength cut filter 10b are stacked on top of the structure via the insulating films 204 and 205. The infrared transmitting filter 11 and short-wavelength cut filter 10b can be stacked in this order or reversed order. In the first embodiment, the infrared transmitting filter 11 and short-wavelength cut filter 10b are stacked in this order on the insulating film 205.

In each of the photodiode portions 1 and 2, the n-type epitaxial layer 8 and p-type diffusion layer 9 are isolated from the circumference by a p⁺-type element isolation region 201, and a p⁺-type buried layer 202 and n⁺-type buried layer 203 are also formed.

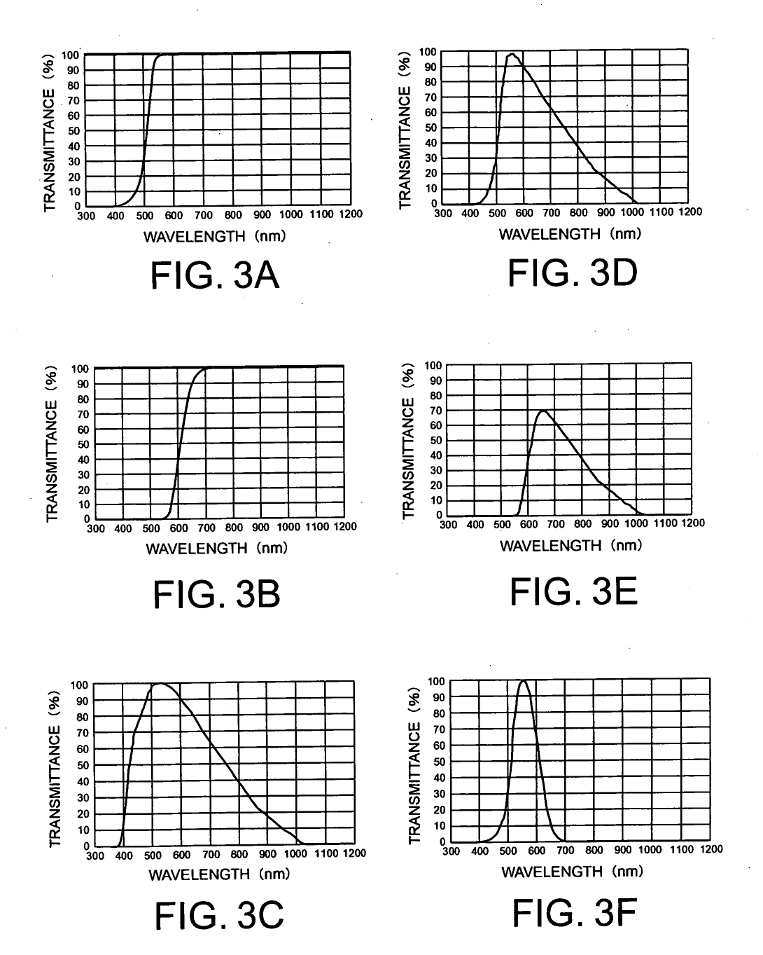

FIG. 3A shows an example of the transmittance characteristic of the short-wavelength cut filters 10a and 10b. As shown in FIG. 3A, the short-wavelength cut filters 10a and 10b have a spectral sensitivity characteristic by which the wavelength at the half width (the wavelength at which the transmittance is 50%) is 400 to 600 nm.

FIG. 3B shows an example of the transmittance characteristic of the infrared transmitting filter 11. The infrared transmitting filter 11 has a spectral sensitivity characteristic by which the wavelength at the half width is 550 to 700 nm.

FIG. 3C shows a spectral sensitivity characteristic obtained when none of the filters 10a, 10b, and 11 is used in the photodiode portions 1 and 2. A photodiode formed on a semiconductor substrate made of silicon has a characteristic by which the transmittance peaks at 500 to 600 nm as shown in FIG. 3C.

FIG. 3D shows a spectral sensitivity characteristic obtained in the photodiode portion 1 using only the short-wavelength cut filter 10a, i.e., obtained when the short-wavelength cut filter 10a having the characteristic shown in FIG. 3A is used in a photodiode having the characteristic shown in FIG. 3C.

FIG. 3E shows a spectral sensitivity characteristic obtained in the photodiode portion 2 using the short-wavelength cut filter 10b and infrared transmitting filter 11, i.e., obtained when the short-wavelength cut filter 10a having the characteristic shown in FIG. 3A and the infrared transmitting filter 11 having the characteristic shown in FIG. 3B are used in a photodiode having the characteristic shown in FIG. 3C.

FIG. 3F shows a spectral sensitivity characteristic finally obtained by the first embodiment by using the photodiode portions 1 and 2. As shown in FIG. 3F, a spectral sensitivity characteristic substantially equal to the spectral sensitivity of a human eye can be obtained by the first embodiment.

The operation of the semiconductor photosensor according to the first embodiment which realizes the spectral sensitivity characteristic as described above will be explained below with reference to FIG. 1.

When the photodiode portions 1 and 2 are irradiated with light having a predetermined illuminance, the photodiode portion 1 outputs a photocurrent from the visible light region to the infrared region transmitted through the short-wavelength cut filter 10a.

The photodiode portion 2 outputs a photocurrent in the infrared region corresponding to the spectral sensitivity characteristic of the infrared transmitting filter 11. These output photocurrents are amplified at equal magnifications by the amplifier 3 having a current mirror configuration made up of transistors 3a and 3b having the same size.

The outputs of the photodiode portion 1 and amplifier 3 are connected to the amplifier 4. The amplifier 4 receives an electric current obtained by subtracting the output of the amplifier 3 from the output of the photodiode portion 1, i.e., an electric current from which the infrared component is subtracted. After that, the amplifiers 4 and 5 and the output circuit 6 amplify the electric current to a necessary magnitude and output the amplified current outside.

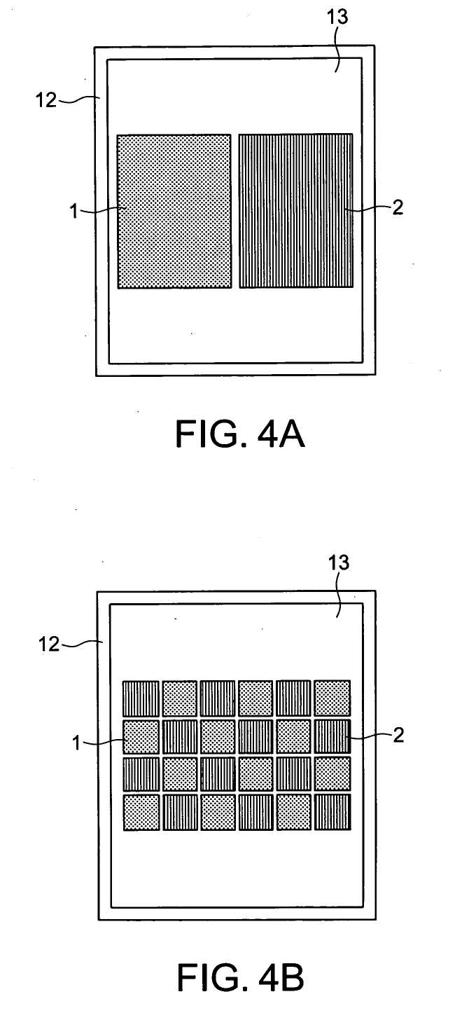

FIG. 4A shows an example of a chip layout pattern in the first embodiment. Referring to FIG. 4A, the photodiode portions 1 and 2 are arranged adjacent to each other.

In a chip layout pattern shown in FIG. 4B, the photodiode portions 1 and 2 are divided into a plurality of portions, and the divided photodiode portions 1 and 2 are alternately arranged adjacent to each other to form a checker pattern. The divided portions of the photodiode portion 1 are connected in parallel by an interconnecting layer not shown in FIG. 1, and the divided portions of the photodiode portion 2 are also connected in parallel by an interconnecting layer not shown in FIG. 1.

In the first embodiment as described above, not only the infrared region but also the short-wavelength region is removed from the optical output from the photodiode. Therefore, a spectral sensitivity characteristic close to the visual sensitivity can be obtained.

FIG. 2B shows the structure of a modification of the first embodiment. This modification uses a short-wavelength cut filter 10c obtained by continuously forming the short-wavelength cut filters 10a and 10b in the first embodiment. This structure obviates the need for patterning for separating the short-wavelength cut filter 10c into 10a and 10b. In addition, obliquely incident light which passes between the short-wavelength cut filters 10a and 10b in the first embodiment passes through the short-wavelength cut filter 10c in this modification. As a consequence, a more desirable characteristic can be obtained.

A semiconductor photosensor according to a reference example will be described below.

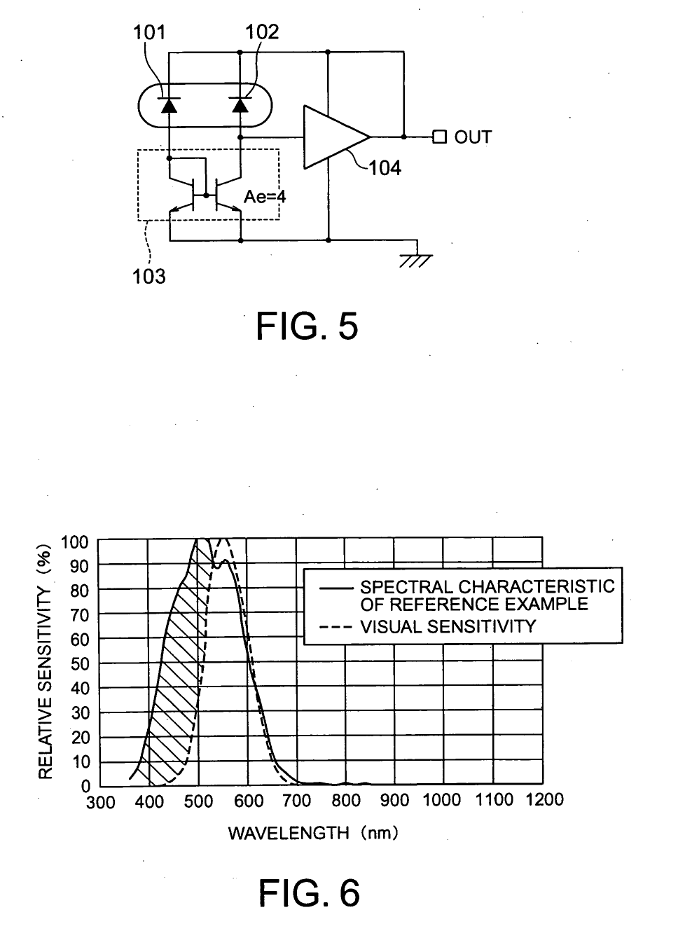

FIG. 5 shows the arrangement of photodiodes and a signal processor for photocurrents in this semiconductor photosensor. The semiconductor photosensor comprises a photodiode 101 using an infrared transmitting filter, and a photodiode 102 using no infrared transmitting filter and having a fourfold area. The photodiode 101 outputs a photocurrent I1, and the photodiode 102 outputs a photocurrent I2.

The photocurrent I2 which is four times as large as the photocurrent I1 from the photodiode 101 flows through an amplifier 103.

A signal processor 104 is connected to the output of the amplifier 103 and the anode of the photodiode 102. The signal processor 104 subtracts the photocurrent I1, which is amplified by the amplifier 103, of the photodiode 101, i.e., an infrared component having passed through the infrared transmitting filter, from the photocurrent I2 of the photodiode 102, and outputs the operation result.

This makes it possible to obtain a spectral sensitivity characteristic having substantially no sensitivity to infrared light, which is indicated by the dotted line in FIG. 6, like a spectral sensitivity characteristic indicated by the solid line in FIG. 6.

Referring to FIG. 6, however, a hatched component at short wavelengths is not removed. This portion is the difference between the spectral sensitivity characteristic of the reference example and the visual sensitivity.

Data based on experiments related to the ratio of the output when an incandescent lamp is lit to the output when a fluorescent lamp is lit (=the output when an incandescent lamp is lit/the output when a fluorescent lamp is lit) in the semiconductor photosensor according to the reference example using the infrared transmitting filter and in a semiconductor photosensor comprising photodiodes using no infrared transmitting filter will be described below.

The ratio of the output when an incandescent lamp is lit to the output when a fluorescent lamp is lit (=the output when an incandescent lamp is lit/the output when a fluorescent lamp is lit) is 1.0 if a photosensor has a spectral sensitivity characteristic matching the visual sensitivity. Accordingly, to perform brightness adjustment or the like of a liquid crystal display by using a semiconductor photosensor, the photosensor is presumably required to have an output ratio of about 0.8 to 1.2.

By contrast, a sensor using no infrared transmitting filter has an output ratio of 1.3 or more, and the sensor using the infrared transmitting filter according to the reference example has an output ratio of 0.8 to 0.9. In the reference example described above, therefore, the use of the infrared transmitting filter improves the ratio of the output when an incandescent lamp is lit to the output when a fluorescent lamp is lit (=the output when an incandescent lamp is lit/the output when a fluorescent lamp is lit), compared to a sensor using no infrared transmitting filter.

Unfortunately, the output when a fluorescent lamp is lit increases. In addition, it is difficult to decrease the output ratio to 0.8 to 1.2 due to variation factors in the mass-production process and the like.

When a photodiode is formed on a semiconductor substrate made of, e.g., silicon, silicon has sensitivity to light having a wavelength of 360 to 550 nm. Therefore, as in the hatched region shown in FIG. 6, a difference is produced in a short-wavelength region between the visual sensitivity and the spectral sensitivity characteristic of the semiconductor photosensor according to the reference example.

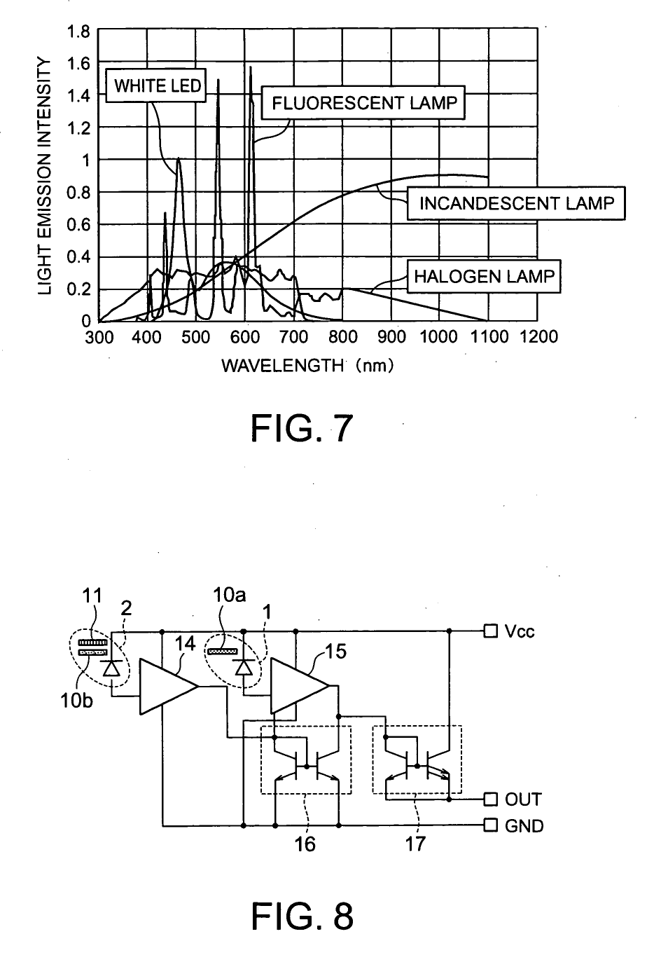

FIG. 7 shows the light emission spectra of light sources generally used as illumination. In the hatched region shown in FIG. 6, i.e., in a wavelength band of 360 to 550 nm, the light emission intensity of an incandescent lamp is low, and that of a halogen lamp is also relatively low.

On the other hand the light emission intensity of a fluorescent lamp having three wavelength bands or a white LED which is attracting attention as energy-saving illumination is high at 360 to 550 nm. In the semiconductor photosensor according to the reference example, therefore, a difference from the visual sensitivity is produced at short wavelengths, so the ratio of the output when an incandescent lamp is lit to the output when a fluorescent lamp is lit (=the output when an incandescent lamp is lit/the output when a fluorescent lamp is lit) is not 1.0.

By contrast, in the semiconductor photosensor of the first embodiment described above, not only the infrared region but also the short-wavelength region is removed from the optical output of the photodiode. Consequently, a spectral sensitivity characteristic close to the visual sensitivity can be realized.

### (2) Second Embodiment

FIG. 8 shows the arrangement of a semiconductor photosensor according to the second embodiment of the present invention. This semiconductor photosensor comprises photodiode portions 1 and 2, amplifiers 14, 15, and 16, and an output circuit 17. A photocurrent from the photodiode portion 2 is amplified by the amplifier 14, and a photocurrent from the photodiode portion 1 is amplified by the amplifier 15. After that, like the amplifier 3 of the first embodiment, the amplifier 16 subtracts the photocurrent of the photodiode 1 from the photocurrent of the photodiode portion 2. The output circuit 17 amplifies the obtained photocurrent, and outputs the amplified photocurrent outside.

The photodiode portions 1 and 2 have the same structure as in the first embodiment, so an explanation thereof will be omitted.

The second embodiment differs from the first embodiment in that the amplifiers 14 and 15 amplify the photocurrents from the photodiode portions 2 and 1 to such an extent that the influence of an electric current of photocarriers generated in the substrate by light incident from the side surface of the chip is negligible, or the influence of a diffusion electric current from the photodiode is negligible.

The output photocurrents from the photodiode portions 2 and 1 are amplified to such an extent that the influence of an electric current of photocarriers generated in the substrate by light incident from the side surface of the chip is negligible, or the influence of a diffusion electric current from the photodiode is negligible. After that, these photocurrents undergo subtraction. Accordingly, the influence of the photocarriers generated in the semiconductor substrate can also be canceled by the subtraction.

The output photocurrents from the photodiode portions 1 and 2 are as very small as a few nA. Therefore, the S/N ratio increases when subtraction is performed after these photocurrents are amplified.

To equalize the influences of light components from the side surfaces of the chip, the layout is preferably given pairness such that the distance from the chip end in the photodiode portion 1 is equal to that in the photodiode portion 2, i.e., the arrangements are equivalent in characteristics.

Also, to equalize the influences which light components from the side surfaces of the chip have on circuit elements forming the amplifiers 14 and 15, and equalize the influences of diffusion electric currents from the photodiode portions 1 and 2, the arrangements of the amplifiers 14 and 15 are preferably symmetrical such that the distances from the photodiode portions 1 and 2 are equal, and the distances from the chip ends are equal.

### (3) Third Embodiment

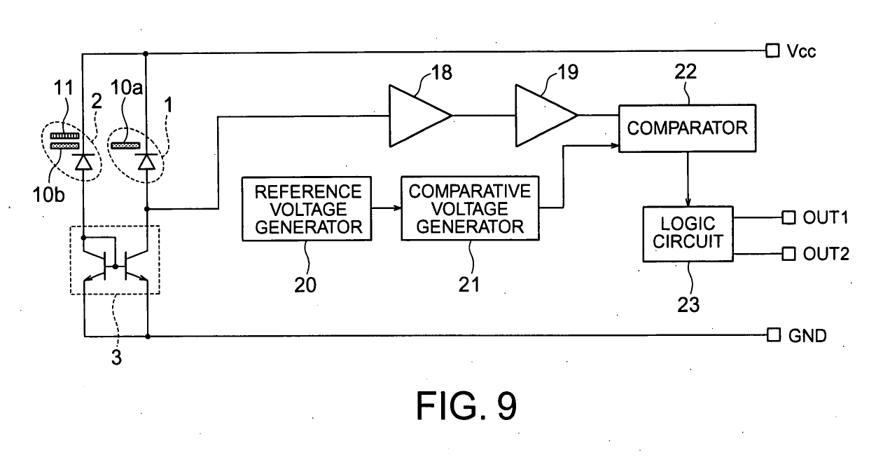

A semiconductor photosensor according to the third embodiment of the present invention will be explained below with reference to FIG. 9 showing the arrangement of the photosensor. This semiconductor photosensor comprises photodiode portions 1 and 2, amplifiers 3, 18, and 19, a reference voltage generator 20, a comparative voltage generator 21, a comparator 22, and a logic circuit 23.

As in the first embodiment, the amplifier 3 subtracts a photocurrent of the photodiode portion 1 from a photocurrent of the photodiode portion 2, thereby matching the characteristic with the visual sensitivity.

After that, the output from the amplifier 3 is amplified by the amplifiers 18 and 19, and input to the comparator 22.

The reference voltage generator 20 generates a reference voltage such as a bandgap constant voltage. On the basis of the reference voltage generated by the reference voltage generator 20, the comparative voltage generator 21 generates a comparative voltage. This comparative voltage is equivalent to a reference value for determining whether the ambient illuminance is one or the other of two stages, in order to turn on or off the backlight of a liquid crystal display or the like.

The comparator 22 compares the comparative voltage output from the comparative voltage generator 21 with that output from the amplifier 19, which has the value corresponding to the photocurrent, and outputs the comparison result. This output from the comparator 22 is input to the logic circuit 23, and the logic circuit 23 outputs a logic signal “1” or “0”.

In the third embodiment, after the photocurrent from the photodiode portion 1 is subtracted from the photocurrent obtained from the photodiode portion 2, the difference is compared with the predetermined comparative voltage. Accordingly, an output to be used to control ON/OFF of, e.g., the backlight of a liquid crystal display can be obtained. This output is given a spectral sensitivity characteristic close to the visual sensitivity by removing the infrared region and short-wavelength region from the optical output of the photodiode.

### (4) Fourth Embodiment

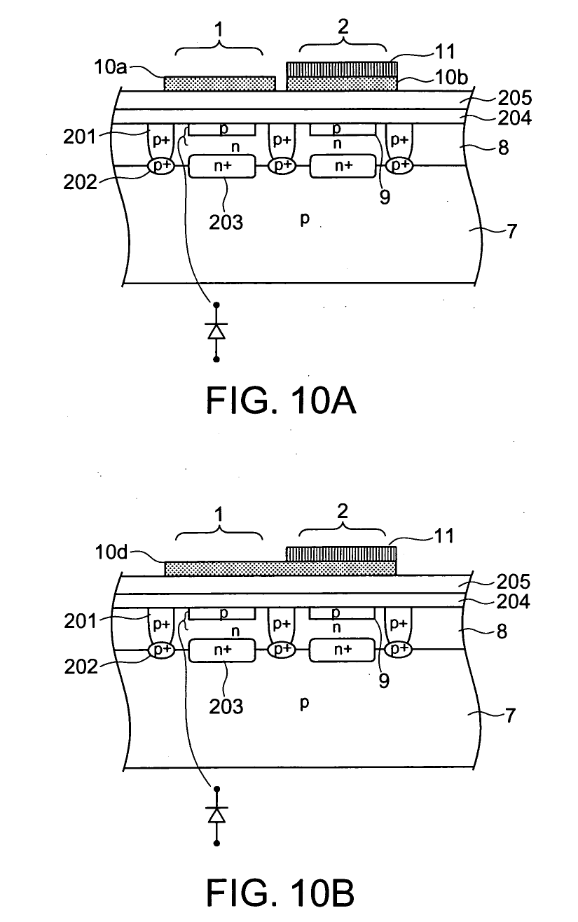

FIG. 10A shows the sectional structure of photodiodes in a semiconductor photosensor according to the fourth embodiment of the present invention. In the first embodiment described previously, the infrared transmitting filter 11 and short-wavelength cut filter 10b are stacked in this order on top of the photodiode portion 2 via the insulating films 204 and 205.

In the fourth embodiment, however, a short-wavelength cut filter 10b and infrared transmitting filter 11 are stacked in this order on an insulating film 205.

In a photodiode portion 2 using this filter stacking order of the fourth embodiment, the short-wavelength cut filter 10b is formed close to an epitaxial layer 8 in which a photodiode is formed, as in a photodiode portion 1. Unlike in the first embodiment, therefore, light obliquely incident from above the photodiode portion 2 passes through the short-wavelength cut filter 10b under the same conditions as light obliquely incident from above the photodiode portion 1, and then enters the photodiode portion 1.

Accordingly, a short-wavelength cut filter 10a in the photodiode portion 1 and the short-wavelength cut filter 10b in the photodiode portion 2 are arranged in equivalent positions, so an operation can be performed at high accuracy when a photocurrent from the photodiode portion 1 is subtracted from a photocurrent from the photodiode portion 2.

In the photodiode portion 2 of the semiconductor photosensor of each of the second and third embodiments, the filters can be stacked in the order described in either the first or fourth embodiment.

FIG. 10B shows the structure of a modification of the fourth embodiment. In this modification, a short-wavelength cut filter 10d is formed by continuously forming the short-wavelength cut filters 10a and 10b in the fourth embodiment. This structure obviates the need for patterning for separating the short-wavelength cut filter 10d into 10a and 10b. In addition, obliquely incident light which passes between the short-wavelength cut filters 10a and 10b in the fourth embodiment passes through the short-wavelength cut filter 10d in this modification. As a consequence, a more desirable characteristic can be obtained.

### (5) Fifth Embodiment

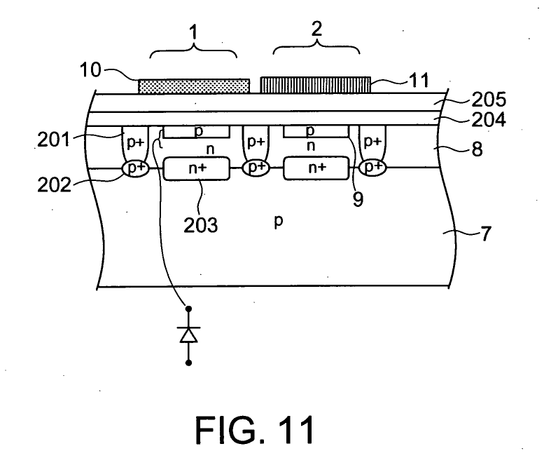

FIG. 11 shows the sectional structure of photodiodes in a semiconductor photosensor according to the fifth embodiment of the present invention. The fifth embodiment differs from the first and fourth embodiments in that no short-wavelength cut filter 10 is formed in a photodiode portion 2, and only an infrared transmitting film 11 is formed on an insulating film 205.

When a short-wavelength cut filter 10 having a very high transmittance in a wavelength band of 550 nm or more as shown in FIG. 3A is used, it is possible to form the short-wavelength cut filter 10 on only a photodiode portion 1, and form only the infrared transmitting filter 11 on the photodiode portion 2.

The photodiode portions 1 and 2 in each of the second and third embodiments may also have the photodiode structures of the fifth embodiment.

In the first to fifth embodiments as described above, in a semiconductor photosensor using photodiodes having a spectral sensitivity characteristic from the visible light region to the infrared region, an operation is performed between a photocurrent output from the photodiode portion 1 on which only the short-wavelength cut filter 10a is formed, and a photocurrent output from the photodiode portion 2 on which the short-wavelength cut filter 10b and infrared transmitting filter 11 are formed, thereby removing the short-wavelength component and infrared component. Accordingly, a semiconductor photosensor having a spectral sensitivity characteristic close to the visual sensitivity can be implemented.

Note that each embodiment described above is merely an example and does not limit the present invention. Therefore, these embodiments can be variously modified within the technical scope of the present invention. For example, the photo detector is not limited to a photodiode, and can be any element which generates an electrical signal corresponding to a received light amount.

What is claimed is:

1. A semiconductor photosensor comprising:
a first photo detector and a second photo detector formed in a surface portion of a semiconductor substrate;
a first resin layer formed on a light-receiving region of the first photo detector, and including a first spectral sensitivity characteristic;
a second resin layer formed on a light-receiving region of the second photo detector, and including a second spectral sensitivity characteristic; and
an operation circuit which performs a predetermined operation between a first output from the first photo detector and a second output from the second photo detector, and outputs a result of the operation,
wherein the first spectral sensitivity characteristic is a characteristic which removes a wavelength component in a short-wavelength region, and the second spectral sensitivity characteristic is a characteristic which removes a wavelength component in an infrared region.

2. A photosensor according to claim 1, wherein a wavelength at a half width of the first spectral sensitivity characteristic when a transmittance is 50% is 400 to 600 nm.

3. A photosensor according to claim 1, wherein a wavelength at a half width of the second spectral sensitivity characteristic when a transmittance is 50% is 550 to 700 nm.

4. A photosensor according to claim 2, wherein a wavelength at a half width of the second spectral sensitivity characteristic when a transmittance is 50% is 550 to 700 nm.

5. A photosensor according to claim 1, wherein the operation circuit subtracts a first photocurrent output from the first photo detector from a second photocurrent-output from the second photo detector.

6. A photosensor according to claim 1, further comprising a first amplifier which amplifies the first output from the first photo detector and outputs the amplified output, and a second amplifier which amplifies the second output from the second photo detector and outputs the amplified output,
wherein the operation circuit performs the predetermined operation between the first output amplified by the first amplifier and the second output amplified by the second amplifier, and outputs a result of the operation.

7. A photosensor according to claim 1, wherein the first photo detector and the second photo detector are arranged adjacent to each other.

8. A photosensor according to claim 1, wherein each of the first photo detector and the second photo detector comprises a plurality of elements, and the plurality of elements of the first photo detectors and the plurality of elements of the second photo detectors are alternately arranged adjacent to each other.

9. A photosensor according to claim 1, further comprising:
a comparative voltage generator which generates a comparative voltage related to illuminance; and
a comparator which compares the comparative voltage with the result of the predetermined operation output from the operation circuit, and outputs a result of the comparison.

10. A semiconductor photosensor comprising:
a first photo detector and a second photo detector formed in a surface portion of a semiconductor substrate;
a first resin layer formed on a light-receiving region of the first photo detector, and including a first spectral sensitivity characteristic;
a second resin layer formed on a light-receiving region of the second photo detector, and including the first spectral sensitivity characteristic;
a third resin layer formed on the light-receiving region of the second photo detector such that the second resin layer and the third resin layer are stacked, and including a second spectral sensitivity characteristic; and
an operation circuit which performs a predetermined operation between a first output from the first light-receiving element and a second output from the second light-receiving element, and outputs a result of the operation,
wherein the first spectral sensitivity characteristic is a characteristic which removes a wavelength component in a short-wavelength region, and the second spectral sensitivity characteristic is a characteristic which removes a wavelength component in an infrared region.

11. A photosensor according to claim 10, wherein the first resin layer is integrated with the second resin layer.

12. A photosensor according to claim 10, wherein the third resin layer is stacked on a surface of the second resin layer on the light-receiving region of the second photo detector.

13. A photosensor according to claim 10, wherein a wavelength at a half width of the first spectral sensitivity characteristic when a transmittance is 50% is 400 to 600 nm.

14. A photosensor according to claim 10, wherein a wavelength at a half width of the second spectral sensitivity characteristic when a transmittance is 50% is 550 to 700 nm.

15. A photosensor according to claim 13, wherein a wavelength at a half width of the second spectral sensitivity characteristic when a transmittance is 50% is 550 to 700 nm.

16. A photosensor according to claim 10, wherein the operation circuit subtracts a first photocurrent output from the first photo detector from a second photocurrent output from the second photo detector.

17. A photosensor according to claim 10, further comprising a first amplifier which amplifies the first output from the first photo detector and outputs the amplified output, and a second amplifier which amplifies the second output from the second photo detector and outputs the amplified output,
wherein the operation circuit performs the predetermined operation between the first output amplified by the first amplifier and the second output amplified by the second amplifier, and outputs a result of the operation.

18. A photosensor according to claim 10, wherein the first photo detector and the second photo detector are arranged adjacent to each other.

19. A photosensor according to claim 10, wherein each of the first photo detector and the second photo detector comprises a plurality of elements, and the plurality of elements of the first photo detectors and the plurality of elements of the second photo detectors are alternately arranged adjacent to each other.

20. A photosensor according to claim 10, further comprising:
a comparative voltage generator which generates a comparative voltage related to illuminance; and
a comparator which compares the comparative voltage with the result of the predetermined operation output from the operation circuit, and outputs a result of the comparison.
